(19) United States
(12) Patent Application Publication
(10) Pub. No.: US 2018/0054570 A1
(43) Pub. Date: Feb. 22, 2018

(54) SYSTEMS FOR EFFECTING PROGRESSIVE DRIVER-DISTRACTION-AVOIDANCE ACTIONS AT A VEHICLE

(71) Applicant: GM GLOBAL TECHNOLOGY OPERATIONS LLC, Detroit, MI (US)

(72) Inventors: Fan Bai, Ann Arbor, MI (US); Marco Rocco, Troy, MI (US); Donald K. Grimm, Utica, MI (US); Dan Shan, Troy, MI (US)

(21) Appl. No.: 15/240,251

(22) Filed: Aug. 18, 2016

(51) Int. Cl. H04N 5/232; G07C 5/02

(52) U.S. Cl. CPC H04N 5/23293; G07C 5/02

(57) ABSTRACT

A portable or embedded system including a hardware-based processing unit and a non-transitory storage device. The storage device includes a vehicle-context module that, via the hardware-based processing unit, obtains vehicle-context data, and includes an application-manager module that, via the hardware-based processing unit, obtains application data relating to an application at a host device. The storage device also includes a policy engine that, via the hardware-based processing unit, determines, based on the vehicle-context data and the application data received, a corresponding policy to be effected at the host device, and an output module that, via the hardware-based processing unit, sends to the host-device a communication indicating a host-device action, corresponding to the policy determined, for affecting host-device operation according to the host-device action. The technology also includes the storage device and methods for performing the referenced functions.

### TECHNICAL FIELD

The present disclosure relates generally to systems to control media presentation and user access to vehicle functions and, more particularly, to systems and methods for determining and implementing progressive driver-distraction-avoidance actions at the vehicle such as diminishing media presentation or limiting driver access to vehicle functions.

### BACKGROUND

Most modern vehicles are equipped by original equipment manufacturers (OEMs) with an infotainment unit that can present audio and visual media. The units can present audio received over the Internet by way of an audio application running at the unit, and present video received from a digital video disc (DVD), for instance.

Barriers to transferring and real-time display rendering video data efficiently and effectively from a remote source to a local device for display include transferring data at a sufficient transfer rate, and limitations at the local device, such as limitations of legacy software and/or hardware at the local device. For example, universal-serial-bus (USB) video class (UVC) is not supported by commercial devices or prevailing infotainment systems.

Most modern host devices, such as legacy vehicles already on the road, do not have high-transfer-rate interfaces. Increasingly, modern vehicles have a peripheral port, such as a USB port, or wireless receiver for relatively low-rate data transfer from a mobile-user device such as a smart phone. Often, the phones do not have a video card and/or the vehicles do not have graphics processing hardware.

In addition, modern host devices receive and present media, in the same manner under all circumstances, irrespective of the device from which the data was received, the type or program source of media, or user or vehicle conditions.

### SUMMARY

The present technology solves these and other challenges. The solution provides an arrangement that can, in addition to transferring and rendering the media, control levels of system-user interactions relating to the media. The interactions are controlled based on relevant circumstances, such as conditions of a subject application, vehicle-context conditions, and/or user conditions. In some embodiments user conditions are inferred from application or vehicle-context conditions. Vehicle data can be leveraged to determine vehicle conditions or user conditions. Application data can indicate application conditions and in some embodiments user conditions. System-user interaction level is controlled in rendering application content without unduly distracting the driver.

The underlying conditions include whether, or a manner by which, the vehicle is being driven or operated otherwise. Other example circumstances include an identity of source or destination application for the media, a type of source or destination application for the media, a group or category of the source or destination application, or a type or category of subject media.

Example manners of affecting transfers or renderings include using various framebuffers or framebuffer settings.

Other examples include diminishing a manner by which media or communications is presented, such as by slowing a sampling rate at a host vehicle infotainment apparatus, delaying presentation of content, adapting presentation of the content—e.g., adjusting text point size—employing a more-salient theme having higher or increased contrast, simplifying display layout, or using less-demanding communication or sensory channels (less-demanding in any of various ways, such as less demanding on user attention, less demanding on system resources), such as by using audio or haptic instead of video to share media, a communication, or a notification.

Example manners of interacting with the user include limiting user access to vehicle functions, such as user access to touch-screen functionality.

In various embodiments, the system is programmed to perform these functions to avoid or at least limit user-distraction during vehicle operation.

The present disclosure in various embodiments relates to a portable system including a hardware-based processing unit and a storage device comprising computer-executable instructions or code that, when executed by the hardware-based processing unit, cause the hardware-based processing unit to perform various operations including receiving, using an application, media content from a source, such as a third-party application server, and delivering content and any rendering instructions, to a host device.

For some embodiments, instead of from a portable system, the host device receives content and any rendering instructions from a local or embedded system. The local or embedded system can be part of or connected to the host device, or part of or connected to a vehicle (e.g., automobile), or vehicle apparatus, including the host device, such as a vehicle human-machine-interface (HMI) module or vehicle display. The local or embedded system includes or is connected to a hardware-based processing unit and a storage device comprising computer-executable instructions or code that, when executed by the hardware-based processing unit, cause the hardware-based processing unit to perform various operations including receiving, using an application, media content from a source, such as a third-party application server, and delivering content and any rendering instructions, to the host device.

In various embodiments, the host device is part of a vehicle, such as an automobile, comprising a universal serial bus (USB) port or any variant, such as wireless USB, and the portable system comprises a USB plug or wireless interface for mating with the automobile.

In some embodiments the host system is part of an automobile, or at least configured for implementation as a part of a vehicle, such as an automobile, having the communication port and the display screen device mentioned.

In one aspect, the technology relates to a portable system including a hardware-based processing unit and a non-transitory storage device comprising. The device includes (i) a vehicle-context module that, via the hardware-based processing unit, obtains vehicle-context data; (ii) an application-manager module that, via the hardware-based processing unit, obtains application data relating to an application at the host device; (iii) a policy engine that, via the hardware-based processing unit, determines, based on the vehicle-context data and application data received, a corresponding policy to be effected at the host device; and (iv) an output module that, via the hardware-based processing unit, sends, to the host-device, a host-device action, corresponding to the policy determined, for affecting host-device operation according to the host-device action.

In various embodiments, the vehicle-context module comprises (a) a vehicle-data acquisition sub-module that, via the hardware-based processing unit, receives vehicle, receives vehicle-operation data; and (b) a vehicle-context inference sub-module that, via the hardware-based processing unit, determines the vehicle-context data based on the vehicle-operation data.

In various embodiments, the portable system further includes (A) an audio-buffer component; (B) a visual-buffer component; (C) a human-machine interface (HMI) component; and (D) an actuation module that, via the hardware-based processing unit, determines which one or more of the components to use in processing the policy determined to render the host-device action. In some implementations, the actuation module comprises or is in communication with an adjustments module that, via the hardware-based processing unit, generates, based on the policy determined, at least one of (1) an audio part, for processing at the audio-buffer component; (2) a visual part, for processing at the visual-buffer component; and (3) an HMI part, for processing at the HMI component.

In various embodiments, the vehicle-context data indicates whether the vehicle is parked or moving. If moving, additional context details can indicate, for instance, an overall driving complexity, ranging from simple to complex, for example, and can be derived, from vehicle usage and the environment.

For some embodiments, instead of a portable system, the host device receives content and any rendering instructions from a local or embedded system. The local or embedded system can be part of or connected to the host device, or part of or connected to a vehicle (e.g., automobile) including the host device. The local or embedded system includes or is connected to a hardware-based processing unit and a storage device comprising computer-executable instructions or code that, when executed by the hardware-based processing unit, cause the hardware-based processing unit to perform various operations including receiving, using an application, media content from a source, such as a third-party application server, and delivering content and any rendering instructions, to the host device.

In various embodiments, the policy includes at least one of (a) a human-machine-interface portion indicating whether a screen or screen-related component of the host device should process user touch input; (b) an audio portion indicating a manner by which an audio component of the host device should function; and (c) a video portion indicating a manner by which a visual component of the host device should function.

In another aspect, the technology includes methods of performing the functions described above, performed by the structure recited.

In another aspect, the technology includes non-transitory computer-readable media configured with customized modules for performing the functions described above, performed by the structure recited.

Other aspects of the present invention will be in part apparent and in part pointed out hereinafter.

### DESCRIPTION OF THE DRAWINGS

FIGS. 1 and 2 illustrate schematically an environment in which the present technology is implemented, including a portable system and a host device.

FIG. 3 illustrates operations of an algorithm programmed at the portable system of FIG. 1.

FIG. 4 illustrates operations of an algorithm programmed at the host device of FIG. 1.

The figures are not necessarily to scale and some features may be exaggerated or minimized, such as to show details of particular components.

In some instances, well-known components, systems, materials or methods have not been described in detail in order to avoid obscuring the present disclosure.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model, or pattern.

Specific structural and functional details disclosed herein are not to be interpreted as limiting, but merely as a basis for the claims and as a representative basis for teaching one skilled in the art to employ the present disclosure.

While select embodiments of the present technology are described in connection with automobiles, the technology is not limited to automobiles. The concepts can be used in a wide variety of applications, such as in connection with aircraft and marine craft, and non-transportation industries such as with televisions.

Other non-automotive implementations can include plug-in peer-to-peer, or network-attached-storage (NAS) devices.

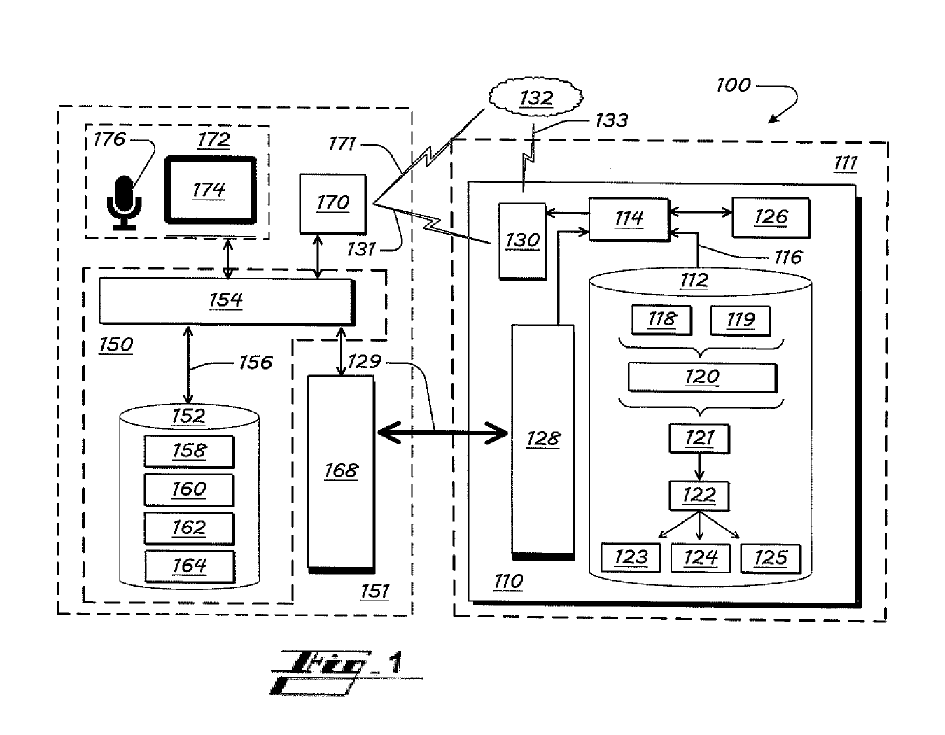

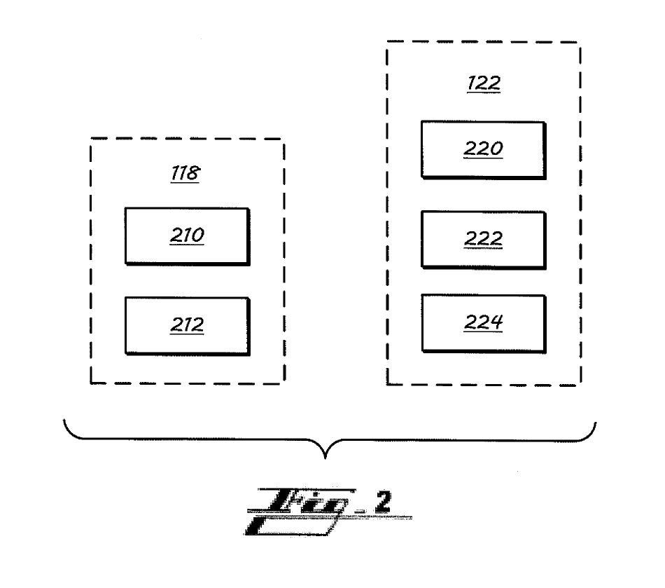

### I. FIGS. 1 AND 2—TECHNOLOGY ENVIRONMENT

FIG. 1 shows an environment 100 in which the present technology is implemented. The environment 100 includes a portable apparatus 110 and a host apparatus 150. For simplicity and not to limit scope, the portable apparatus 110 is referred to at times herein as a portable system, and the host apparatus 150 as a host device. In one embodiment, the portable system and host device 110, 150 are a consolidated system.

The portable system 110 can take any of a variety of forms, and be referenced in any of a variety of other ways—such as by peripheral device, peripheral system, portable peripheral, peripheral, mobile system, mobile peripheral, portable system, and portable mass-storage system.

The system 110 can be referred to as being portable based on any of a variety of reasons, such as by being readily attachable/removable to/from the host device, such as by a plug-in arrangement, and/or by being mobile, such as by being wireless and compact for being readily carried about by a user. The portable system 110 can include or be part of another apparatus 111 such as dongle or a mobile communications device such as a smart phone.

For some embodiments, instead of the system 110 being portable, the system 110 is local or embedded and, still, provides content and any rendering instructions to the host device. The local or embedded system 110 can be part of or connected to the host device, or part of or connected to a vehicle (e.g., automobile) including the host device. The local or embedded system includes or is connected to a hardware-based processing unit and a storage device comprising computer-executable instructions or code that, when executed by the hardware-based processing unit, cause the hardware-based processing unit to perform various operations including receiving, using an application, media content from a source, such as a third-party application server, and delivering content and any rendering instructions, to the host device. While the system 110 is described primarily herein as a portable system 110, any of the embodiments described regarding a portable system 110 disclose inherently embodiments in which the system 110 is local or embedded.

Although connections are not shown between all of the components of the portable system 110 and the host device 150, the components interact with each other to carry out the functions described herein.

The portable system 110 includes a hardware storage device 112. The hardware storage device 112 can be referred to by other terms, such as a memory, or computer-readable medium, and can include, e.g., volatile medium, non-volatile medium, removable medium, and non-removable medium. The term hardware storage device and variants thereof, as used in the specification and claims, refer to tangible or non-transitory, computer-readable storage devices. The component is referred to primarily herein as a hardware storage device 112.

In some embodiments, storage media 112 includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

The portable system 110 also includes a processing hardware unit 114 connected or connectable to the hardware storage device 112 by way of a communication link 116, such as a computer bus.

The processing hardware unit 114 can be referred to by other terms, such as processing hardware unit, processing hardware device, processing hardware system, processing unit, processing device, or the like.

The processing hardware unit 114 could be multiple processors, which could include distributed processors or parallel processors in a single machine or multiple machines. The processing hardware unit 114 can be used in supporting a virtual processing environment.

The processing hardware unit 114 can include or be a multicore unit, such as a multicore digital signal processor (DSP) unit or multicore graphics processing unit (GPU).

The processing hardware unit 114 can be used in supporting a virtual processing environment. The processing hardware unit 114 could include a state machine, application specific integrated circuit (ASIC), programmable gate array (PGA) including a Field PGA (FPGA), DSP, GPU, or state machine.

The portable system 110 in various embodiments comprises one or more complimenting media codec components, such as a processing or hardware component, and a software component to be used in the processing. The hardware or processing component can be a part of the processing device 114.

References herein to a processor or processing hardware unit 114 executing code or instructions to perform operations, acts, tasks, functions, steps, or the like, could include the unit 114 performing the operations directly and/or facilitating, directing, or cooperating with another device or component to perform the operations.

The hardware storage device 112 includes structures such as modules, engines, and components, which include computer-executable instructions or code for performing functions of the present technology. the modules, engines, and components are each referred to primarily herein as modules.

Code, whether part of the modules, is executed by the processing hardware unit 114 to cause the processing hardware unit and thus the portable system 110 to perform any combination of the functions described herein regarding the portable system. In contemplated embodiments, the processing hardware unit 114 is part of any of the modules.

Each of the modules and sub-modules can be referred to by any of a variety of names, such as by a term or phrase indicative of its function.

The structures of the hardware storage device 112 in various embodiments includes:
a vehicle-context module 118;
an application-manager module 119;
a flexible, configurable policy engine or module 120;
an actuation module 121;
an adjustments module 122;
an audio-buffer module or component 123;
a framebuffer, or visual-media, module or component 124; and
a human-machine interface (HMI), or user input/output, module or component 125.

Sub-modules can cause the processing hardware unit 114 to perform specific operations or routines of module functions. Each sub-module can also be referred to by any of a variety of names, such as by a term or phrase indicative of its function.

In a contemplated embodiment, modules 123, 124, 125 are part of the adjustments module 122, or other output-related module, any of which can be referred to as an output module, and any of these modules can be part of the actuation module 121.

FIG. 2 shows further detail of the vehicle-context module 118 and the adjustments module 122.

The vehicle-context module 118 in various embodiments includes:
a vehicle-data acquisition sub-module 210; and
a vehicle-context inference sub-module 212.

The adjustments module 122 in various embodiments includes:
an audio-buffer adjustment sub-module 220;
a framebuffer adjustment sub-module 222; and
a user input/output adjustment sub-module 224.

The hardware storage device 112 in various embodiments includes a file sub-system (not shown in detail), which can include a first level cache and in some implementations also a second level cache.

The hardware storage device 112 in various embodiments includes a media codec component (not shown in detail), such as a processing, or hardware component, and a software component.

The hardware storage device 112 in various embodiments includes a framebuffer capture component (not shown in detail). A framebuffer of display screen can be, for example, a transferred video source, such as in the form of a data content package, captured by the framebuffer capture component.

The device 112 in various embodiments stores at least some of the data received and/or generated, and to be used in processing, in a file-based arrangement corresponding to the code stored therein. For instance, when an FPGA is used, the hardware storage device 112 can include configuration files configured for processing by the FPGA.

Any of the hardware storage device 112 components may be combined, separated, or removed. References herein to portable-system operations performed in response to execution of any memory 112 component can be performed by execution of another, or a combined or separated, memory 112 component. For instance, if instructions of a first component of code is described as being configured to cause the processing hardware unit 114 to perform a certain operation or set of operations, instructions of another component of the memory, including or fully distinct form the first code, 112 can be configured to cause the processing hardware unit 114 to perform the operation(s).

In some embodiments, the hardware storage device 112 includes code of a dynamic programming language (not called out in detail in the drawings), such as JavaScript, Java or a C/C++ programming language. The host device 150 includes the same programming language. The programming-language component of the host device 150, in some implementations includes an application framework, such as the media application mentioned and/or an application manager for managing operations of the media application at the host device 150.

The programming language code can define settings for communications between the portable system 110 and the host device 150, such as features of one or more application program interfaces (APIs) by which the portable system 110 and the host device 150 communicate.

The portable system 110 in some embodiments includes at least one human-machine interface (HMI) component 126. For implementations in which the interface component 126 facilitates user input to the processing hardware unit 114 and output from the processing hardware unit 114 to the user, the interface component 126 can be referred to as an input/output (I/O) component.

As examples, the interface component 126 can include, or be connected to, a sensor configured in any of a variety of ways to receive user input. In various implementations the interface component 126 includes at least one sensor configured to detect user input provided by, for instance, a touch, an audible sound or a non-touch motion or gesture.

A touch-sensor interface component can include a mechanical actuator, for translating mechanical motion of a moving part such as a mechanical knob or button, to an electrical or digital signal. The touch sensor can also include a touch-sensitive pad or screen, such as a surface-capacitance sensor. The sensor can also include infrared components of a touch-sensor interface, as well.

For detecting gestures, the interface component 126 can include or use a projected-capacitance sensor, an infrared laser sub-system, a radar sub-system, or a camera sub-system, by way of examples.

The interface component 126 is connected to the processing hardware unit 114 for passing user input received as corresponding signals or messages to the hardware-based processing unit.

In various implementations the interface component 126 includes or is connected to any suitable output devices—for example, a visual or audible indicator such as a light, digital display, or tone generator, for communicating output to the user.

The interface component 126 can be used to affect functions and settings of one or both of the portable system 110 and the host device 150 based on user input. Signals or messages corresponding to inputs received by the interface component 126 are transferred to the processing hardware unit 114, which, executing code of the hardware storage device 112, sets or alters a function at the portable system 110. Inputs received can also trigger generation of a communication, such as an instruction or message, for the host device 150, and sending the communication to the host device 150 for setting or altering a function or setting of the host device 150.

The portable system 110 is in some embodiments configured to connect to the host device 150 by a wireless communication 131 or by a hard, or wired connection 129. The wired connection is referred to primarily herein as being wired in a non-limiting sense. The connection can include components connecting wires, such as the USB plug-and-port arrangement described, or wireless component such as wireless USB.

In some embodiments, the connection is configured with connections according to higher throughput arrangements, such as using an HDMI port or a VGA port.

The portable system 110 can, as mentioned, be configured as a dongle, such as by having a data-communications plug 128 for connecting to a matching data-communications port 168 of the host device 150. An example data-communications plug 128 is a USB plug, for connecting to a USB port of the host device 150.

In these ways, advanced functions are available by way of relatively low-rate connection, such as USB device class components, whereas they would not otherwise be. And if a higher- or high-capability class device is available (e.g., if the vehicle is already configured with or for such device class), the system can be configured to directly use the higher-capability class device to provide the advanced functions.

For instance, while the portable system 110 is in some embodiments a portable mass-storage device, more advanced USB device classes such as Media Transfer Protocol (MTP) could be supported.

The portable system 110 is configured in various embodiments to operate any one or more of a variety of types of computer instructions that it may be programmed with for dynamic operations and/or that it may receive for dynamic processing at the system 110

In some embodiments, the portable system 110 is configured for wireless communications with the host device 150 and/or another system 132 external to the portable system 110, such as a remote network or database. By numeral 130 in FIG. 1, a wireless input or input/output (I/O) device—e.g., transceiver—or simply a transmitter, is referenced. Wireless communications with the host device 150 and external system 132 are referenced by numerals 131, 133, respectively.

The wireless device 130 can in various embodiments communicate with any of a wide variety of networks, including cellular communication networks, satellite networks, and local networks such as by way of a roadside-infrastructure or other local wireless transceiver, beacon, or hotspot. The wireless device 130 can also communicate with near-field communication (NFC) devices to support functions such as mobile payment processing, or communication setup/handover functions, or any other use cases that are enabled by NFC. The wireless device 130 can include for example, a radio modem for communication with cellular communication networks.

The remote system 132 thus in various embodiments includes any of cellular communication networks, road-side infrastructure or other local networks, for reaching destinations such as the Internet and remote servers. The remote system 132 may be a server, and may be a part of, or operated by, a customer-service center or system, such as the OnStar® system (ONSTAR is a registered trademark of Onstar LLC of Detroit, Mich.).

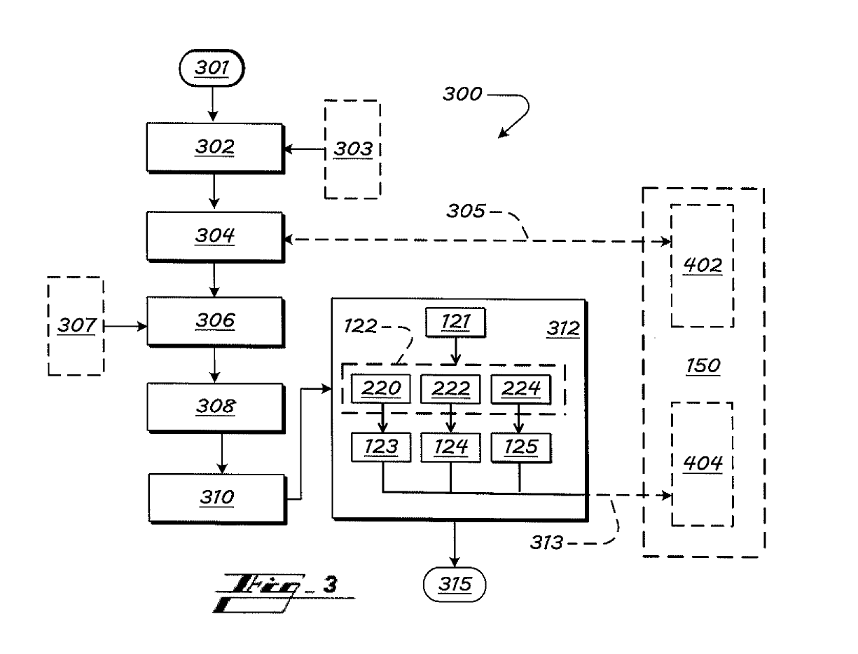

Other features of the portable system 110 are described below, primarily in connection with the algorithm of FIG. 3.

The host device 150 is, in some embodiments, part of a greater system 151, such as an automobile.

As shown, the host device 150 includes a memory, or computer-readable medium 152, such as volatile medium, non-volatile medium, removable medium, and non-removable medium. The term computer-readable media and variants thereof, as used in the specification and claims, refer to tangible or non-transitory, computer-readable storage devices. The component is referred to primarily herein as a storage device 152.

In some embodiments, storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

The host device 150 also includes an embedded computer hardware-based processing unit 154 connected or connectable to the storage device 152 by way of a communication link 156, such as a computer bus.

The hardware-based processing unit could be multiple processors, which could include distributed processors or parallel processors in a single machine or multiple machines. The hardware-based processing unit can be used in supporting a virtual processing environment. The hardware-based processing unit could include a state machine, application specific integrated circuit (ASIC), programmable gate array (PGA) including a Field PGA, or state machine. References herein to hardware-based processing unit executing code or instructions to perform operations, acts, tasks, functions, steps, or the like, could include the hardware-based processing unit 154 performing the operations directly and/or facilitating, directing, or cooperating with another device or component to perform the operations.

The device 152 in various embodiments stores at least some of the data received and/or generated, and to be used in processing, in a file-based arrangement corresponding to the code stored therein. For instance, when an FPGA is used, the hardware storage device 152 can include configuration files configured for processing by the FPGA.

The storage device 152 includes computer-executable instructions, or code. The computer-executable code is executable by the hardware-based processing unit 154 to cause the hardware-based processing unit, and thus the host device 150, to perform any combination of the functions described in the present disclosure regarding the host device 150.

The storage 152 of the host device 150 in various embodiments includes an application(s) framework or module 158, an audio-media module 160, a framebuffer or visual-media module 162, and a HMI module 164.

The storage 152 of the host device 150 in various embodiments also includes any of: other code or data structures, such as a file sub-system; and a dynamic-programming-language (e.g., JavaScript, Java or a C/C++ programming language—not shown in detail in the figures).

Any such memory 152 components may be combined, separated, or removed. References herein to host system operations performed in response to execution of any memory 152 component can be performed by execution of another, or a combined or separated, memory component. For instance, if first code is described as being configured to cause the hardware-based processing unit 154 to perform a certain operation or set of operation(s), other code, including or fully distinct form the first code, can be configured to cause the hardware-based processing unit 154 to perform the operation(s).

The file sub-system can include a first level cache and a second level cache. The file sub-system can be used to store media, such as video or image files, before the hardware-based processing unit 154 publishes the file(s).

The dynamic-programming-language (e.g., JavaScript, Java or a C/C++ programming language (not shown in detail) and/or application framework 158 can be part of the second level cache. The dynamic-programming-language is used to process media data, such as image or video data, received from the portable system 110. The programming language code can define settings for communications between the portable system 110 and the host device 150, such as characteristics of one or more APIs.

The host device 150 includes or is in communication with one or more interface components 172, such as an HMI component. For implementations in which the components 172 facilitate user input to the hardware-based processing unit 154 and output from the hardware-based processing unit 154 to the user, the components can be referred to as input/output (I/O) components.

For output, the interface components can include a visual-output or display component 174, such as a screen, and an audio output such as a speaker. In a contemplated embodiment, the interface components 172 include components for providing tactile output, such as a vibration to be sensed by a user, such as by way of a steering wheel or vehicle seat to be sensed by an automobile driver.

The interface components 172 are configured in any of a variety of ways to receive user input. The interface components 172 can include for input to the host device 150, for instance, a mechanical or electro-mechanical sensor device such as a touch-sensitive display, which can be referenced by numeral 174, and/or an audio device 176 such as an audio sensor—e.g., microphone—or audio output such as a speaker. In various implementations, the interface components 172 includes at least one sensor. The sensor is configured to detect user input provided by, for instance, touch, audibly, and/or by user non-touch motion, such as by gesture.

A touch-sensor interface component can include a mechanical actuator, for translating mechanical motion of a moving part such as a mechanical button, to an electrical or digital signal. The touch sensor can also include a touch-sensitive pad or screen, such as a surface-capacitance sensor. For detecting gestures, an interface component 172 can use a projected-capacitance sensor, an infrared laser sub-system, a radar sub-system, or a camera sub-system, for example.

The interface component 172 can be used to receive user input for affecting functions and settings of one or both of the portable system 110 and the host device 150. Signals or messages corresponding to inputs are generated at the component 172 and passed to the hardware-based processing unit 154, which, executing code of the storage device 152, sets or alters a function or setting at the host device 150, or generates a communication for the portable system 110, such as an instruction or message, and sends the communication to the portable system 110 for setting or altering a function or setting of the portable system 110.

The host device 150 is in some embodiments configured to connect to the portable system 110 by wired connection 129. The host device 150 is in a particular embodiment configured with or connected to a data-communications port 168 matching the data-communications plug 128 of the portable system 110. An example plug/port arrangement provided is the USB arrangement mentioned. Another example could be wireless USB protocol.

In some embodiments, the host device 150 is configured for wireless communications 131 with the portable system 110. A wireless input, or input/output (I/O) device—e.g., transceiver—of the host device 150 is referenced by numeral 170 in FIG. 1. The hardware-based processing unit 154, executing code of the storage device 152, can wirelessly send and receive information, such as messages or packetized data, to and from the portable system 110 and the remote system 132 by way of the wireless device 170 as indicated by numerals 131, 171, respectively.

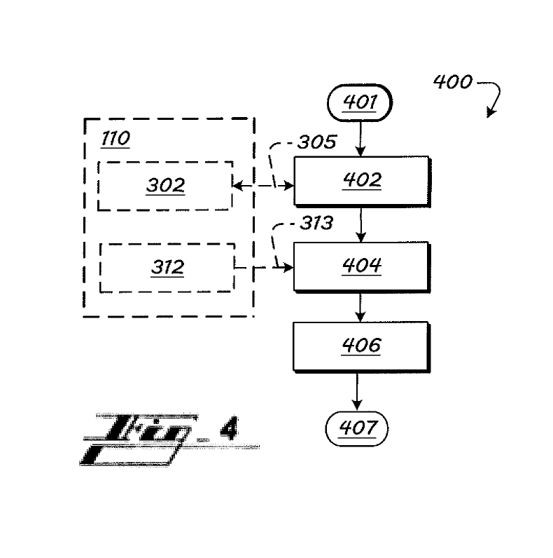

Other features and functions of the host device 150 are described below, primarily in connection with the algorithm of FIG. 4.

### II. FIGS. 3 AND 4—ALGORITHMS AND FUNCTIONS

II.A. Introduction to Algorithms and Functions

Example algorithms by which the present technology is implemented are now described in more detail. The algorithms are outlined by flow charts arranged as methods 300, 400 in FIGS. 3 and 4.

FIG. 3 illustrates primarily operations of an algorithm programmed at the portable system 110 of FIG. 1. FIG. 4 illustrates primarily operations of an algorithm programmed at the host device 150.

It should be understood that operations of the methods 300, 400 are not necessarily presented in a particular order and that performance of some or all the operations in an alternative order is possible and contemplated.

The operations have been presented in the demonstrated order for ease of description and illustration. Operations can be added, omitted and/or performed simultaneously without departing from the scope of the appended claims.

It should also be understood that the illustrated algorithms 300, 400 can be ended at any time. In certain embodiments, some or all operations of this process, and/or substantially equivalent operations are performed by execution by the hardware-based processing units 114, 154 of computer-executable code of the storage devices 112, 152 provided herein.

Operations described, by way of example in connection with embodiments herein, as being performed by a certain device, need not in every embodiment be performed by that structure. Activity described as being performed by the portable system 110, or particularly the processing unit 114 or a module thereof, may be performed by a remote apparatus, for instance, or the host device 150, having corresponding structure, such as the subject module(s)/sub-module(s) for performing the activity.

In various embodiments, the present technology includes an arrangement that can transfer and render media, and interact with the user regarding the media, in a manner tailored to circumstances, including user or vehicle conditions. In various embodiments, the system is programmed to perform these functions toward a goal of avoiding or limiting user-distraction during vehicle operation.

II.B. Portable System Operations—FIG. 3

The algorithm 300 of FIG. 3 is described primarily from the perspective of the portable system 110 of FIG. 1.

The algorithm 300 commences 301 and flow proceeds to a first-illustrated operation 302 whereat in contemplated embodiments, the portable system 110 can be personalized or customized, such as by settings, functions, or user preferences. These can be programmed to the portable system 110 by any of a variety of methods, including by way of the host device 150, a personal computer (now shown), a mobile phone, or the like. Such inputs are represented schematically by numeral 303 in FIG. 3.

In some embodiments, default settings or preferences are provided before any personalization is performed. The settings or functions to be personalized can include any of those described herein, such as settings affecting how the flexible, configurable policy engine or module 120 determines, based on vehicle data and/or application data received, one or more corresponding policies or vehicle-function limitations on vehicle actions to be made or taken, accordingly. In contemplated embodiments, the settings or functions to be personalized include any of those described herein, such as a manner by which incoming media (e.g., video) is processed, or playback qualities at the host device 150 such as rewind, fast-forward.

The configurable policy engine or module 120, whether adjusted at block 302, in various embodiments includes a flexible, reconfigurable tuple table, describing what app should take what user-distraction action under what context scenario. The module 120 is reconfigurable based on a subject application and a context such as a context related to host-device operation—e.g., vehicle 10 operation, and can at any time determine, based on the reconfigured state, an appropriate action or actuation corresponding to the app and context data. The reconfiguration can include adjusting the tuple table that the module 120 uses to determine user-device action based on the circumstances.

Arrangement of policy at the portable device 110 is flexible so that designers or maintainers of the device 110 can configure the acting system, including the configurable policy engine or module 120, to act as desired in response to various app and vehicle data.

By the configurable, or flexible arrangement, the acting mechanism is separate from policy. Thus, changes to policy will not require corresponding overhauls of system architecture and mechanisms.

At block 304 of the algorithm 300, the portable system 110 is placed in communication with the host device 150. Corresponding activity of the host device 150 for this interaction 302 is described further below in connection with FIG. 4, and particularly block 402 of FIG. 4.

Example host devices 150 include a head unit, or an on-board computer, of a transportation vehicle such as an automobile.

The portable system 110 is in one embodiment configured as a dongle, such as by having a data-communications plug 128—e.g., USB plug—for connecting to a matching port 168 of the host device 150.

For communications between the portable system 110 and the host device 150, each can include at their respective storage devices 112, 512, a protocol operable with the type of connection. With the USB plug/port example, the protocol can be a USB mass-storage-device-class (MSC) computing protocol. Other, for example, more advanced, USB protocols, such as Media Transfer Protocol (MTP), could also be supported.

The operation 304 establishes a channel by which data and communications such as messages or instructions can be shared between the portable system 110 and the host device 150.

The portable system 110 can in various embodiments connect to the host device 150 by wire 129 (e.g., plug to port) or wirelessly 131. Both manners are considered represented schematically by numeral 305 in FIGS. 3 and 4.

The portable system 110 connected communicatively with the host device 150 in some embodiments performs a handshake process with the host device 150. The handshake process can also be considered indicated by reference 305 in FIG. 3.

For embodiments in which both devices include a dynamic programming language (not shown in detail), such as JavaScript, Java or a C/C++ programming language, the operation 304 can include a handshake or other interfacing routine between the portable system 110 and the host device 150 using the dynamic programming language.

Flow of the algorithm 300 proceeds to block 306 whereat the processing hardware unit 114 (FIG. 1) executing the vehicle context module 118 (FIG. 1), receives, retrieves, or otherwise obtains vehicle data, such as vehicle Controller Area Network (CAN) data, from a vehicle-data source 307. In various embodiments, the vehicle data is received from sources 307 such as vehicle sensors or on-board computer system module(s). In a contemplated embodiment, the source 307 includes a source external to the vehicle, such as a server of the OnStar® system mentioned.

In embodiments in which the vehicle-context module 118 includes the vehicle-data acquisition sub-module 210 and the vehicle-context inference sub-module 212, the vehicle-data acquisition sub-module 210, executed by the processor 114, receives the vehicle data.

In various embodiments, the vehicle data obtained relates to vehicle operations. The vehicle data indicates any of a wide variety of vehicle conditions, characteristics, statuses, states, modes, or the like. For brevity, these are referred to collectively as vehicle conditions herein. Example vehicle conditions include a manner by which the vehicle is being driven and/or operated otherwise, such as the vehicle being operated in a challenging driving situation, the vehicle being driven under normal conditions, and the vehicle being parked.

In contemplated embodiments, vehicle conditions include a manner by which the vehicle is being driven or operated, such as the vehicle being driven at high speed (requiring relatively high user attention, especially when data being processed indicates that other vehicles, obstacles, road edges, turns, etc. are near), the vehicle being driven in a stop-and-go situation (requiring relatively high user attention, at least in the go periods). The vehicle data can thus include or be used to determine indications of such referenced ancillary conditions, such as nearby vehicles or other obstacles, road edges, elevation changes, turns, an amount and/or type of user involvement to be needed, the like, and other.

In contemplated embodiments, the vehicle data can also include any data used in modern telematics functions.

For embodiments in which the module 118 includes the vehicle-data acquisition sub-module 210 and the vehicle-context inference sub-module 212, at block 308, the latter, executed by the processor 114, processes the vehicle data received, rendering inferred, vehicle-related context information. The vehicle-related context information is used at the flexible, configurable policy engine or module 120. In a contemplated embodiment, this further processing is not needed and the flexible, configurable policy engine or module 120 uses data received directly from the vehicle-data acquisition sub-module 210.

For embodiments having the further processing, the inferred vehicle-related context information can include any of a wide variety of context information. As an example, the vehicle-related context information can indicate a user condition, state, activity or action performance, needed, or suggested, the like, or other, which are for brevity referred to collectively as user conditions.

User conditions can include, sitting in a parked vehicle, sitting in a still vehicle in stop-and-go traffic, sitting in a slowly moving vehicle in the traffic, driving a challenging route, driving at high speed, driving at an average speed and in normal or non-challenging situation, a determined need or suggestion to do any of these, etc.

As described further below, user conditions can also be determined in other ways, separately or additionally, such as based on vehicle sensor data—e.g., a vehicle camera, user actuation of vehicle controls, such as steering wheels, brake pedal or throttle, etc. In various embodiments, user conditions include driver head position, gaze, or whether and how hands are on the steering wheel—e.g., whether both hands and hand position. The system is in some embodiments configured to determine that some host device actions (e.g., delivering a communication, providing application content, providing the content at a certain level or via certain channel, etc.) are safe when hands are off of the wheel, such as if the vehicle is operating safely in an autonomous or semi-autonomous mode.

In a contemplated example, user conditions can be inferred in connection with at least one subject application, such as by being inferred based on selections that the user makes via an HMI of a vehicle in using or attempting to use the application, such as user selection of app functions, settings, etc.

In contemplated embodiments, the vehicle condition and/or the user condition relate to an attention level of the user, such as by indicating a condition in which the user would apparently have little surplus attention to give while still being able to safely operate the vehicle, or indicating a condition in which the user would apparently have attention bandwidth to take on additional stimuli, such as louder music, louder audio, or video presentation, and attending to communications such as reading or sending texts or emails when not driving, or taking calls when safe under the circumstances, whether driving, as a few examples. Other driver states or driver-related include: whether the driver is in an active telephone call, driver age (e.g., teen, elderly), in-cabin environmental conditions, presence of passengers, whether any passengers are children, whether there are in-cabin conversations, content of in-cabin conversations, cabin or external temperature.

At block 310, the processing hardware unit 114, executing the application-manager module 119, receives, generates, or otherwise obtains subject program or subject application data. The application data indicates any of a wide variety of application conditions, characteristics, statuses, states, modes, or the like. For brevity, these are referred to collectively as application conditions.

Example application conditions include a name of the application, a type of the application, an application or program group to which the application belongs, and functions, outputs, or other features of the application.

As mentioned, user conditions are in some embodiments determined based on any of vehicle data (e.g., vehicle-operations data), vehicle-sensor data, and application-related data. Regarding the latter, user conditions can be inferred in connection with a subject application or applications, such as selections that the user makes via an HMI of a subject vehicle in using or attempting to use the application, such as user selection of app functions, settings, etc.

In various embodiments, the application data indicates an application condition including any of an identity of source or destination application for the media; a type of source or destination application for the media; and a type of media.

A source or destination of the media can be indicated by an identity of a program or application providing or receiving the media. Media from a first identified application causes the system to transfer or render the media, or interact with the user, in a manner different that the system would for media from a distinct, second identified application in some embodiments.

Further regarding media source or destination, media from or for a first identified type of application, such as any navigation application, can cause the system to transfer or render the media, or interact with the user, in a manner different that the system would media from or for a second type of application, such as a video application.

Regarding media type, media of a first type, such as navigation media, can cause the system to transfer or render the media, or interact with the user, in a manner different that the system would regarding a second type of media, such as video media.

Versions of the subject application can be running at the portable system 110 and/or at the host device 150. The application can be a media or multimedia application, such as a video application serviced by a remote video application server.

An identity of the application can be indicated in any of a variety of ways. As examples, the application can be identified by application name, code, number, or other indicator.

The application condition in some embodiments includes an application category. Example application categories include live-video-performance, stored-video, video game, text/reader, animation, navigation, traffic, weather, and any category corresponding to one or more infotainment functions.

In a contemplated embodiment, distinct categories include applications of a same or similar type or genre based on characteristics distinguishing the applications. For instance, a first weather application could be associated with a first category based on its characteristics while a second weather application is associated with another category based on its characteristic. To illustrate, below is a list of six (6) example categories. The phrasing heavy, medium, and light indicate relative amounts of the format of media (e.g., moving map, video, or text) that is expected from, e.g., historically provided by, applications.
1. Heavy moving map/heavy imaging/light video/light text (e.g., some weather apps)
2. Light moving map/medium imaging/light video/heavy text (e.g., some other weather apps)
3. Heavy moving map/medium text (e.g., some navigation apps)
4. Medium moving map/high text (e.g., some other navigation apps)
5. Light text/heavy imaging and/or video (e.g., some e-reading apps, such as children's-reading or visual education e-reading applications)
6. Heavy text/light imaging (e.g., some other e-reading apps).

The application condition—application-data source, application-data destination, application identity, application category, etc.—can be obtained in any of a variety of ways. The condition is in various embodiments predetermined and stored at the hardware storage device 112 of the portable system 110 or predetermined and stored at the storage device 152 of the host device 150.

In one embodiment, the condition is indicated in one or more files. The file can contain a lookup table, mapping each of various applications (e.g., a navigation application) to a corresponding application condition(s). The file can be stored at the storage device 152 of the host device 150, or at another system, such as a remote server, which can be referenced by numeral 132 in FIG. 1.

In a contemplated embodiment, an application category relates to a property or type of the subject application. In a contemplated embodiment, the application category is determined in real time based on activities of the application instead of by receiving or retrieving an indicator of the category. The processing hardware unit 114 can determine the application category to be weather, or traffic, for instance, upon determining that the visual media being provided is a moving map overlaid with weather or traffic, respectively.

In a contemplated embodiment, determining the category includes creating a new category or newly associating the application with an existing application. While the application may not have been pre-associated with a category, the processing hardware unit 114 may determine that the application has a particular property or type lending itself to association with an existing category. In a particular contemplated embodiment, the instructions are configured to cause the processing hardware unit 114 to establish a new category to be associated with an application that is determined to not be associated with an existing category. In one embodiment, a default category exists or is established to accommodate such applications not matching another category.

At block 312, the flexible, configurable policy engine or module 120 determines, based on the vehicle data and/or the application data received, one or more policies to be translated, by subsequent modules 121, 122, to actions to be effected at the host device 150. Results of the policy module 120 can be referred to by any of a variety of terms, such as action-policy or actuation-policy data, which are processed to render action or actuation data embodying actions, actuations, or functions to be effected at the host device 150.

Vehicle actions can be executed at any of a wide variety of vehicle components or components connected or in communication with the vehicle. The actions are in various embodiments categorized as allowing or disallowing actions.

Disallowing actions can also be referred to as limiting actions, or blocking actions, as just a couple of examples. In various embodiments, these include any action that limits a manner or extent to which a user can enjoy or otherwise use one or more select vehicle functions. As an example, a disallowing action can include setting the infotainment system so that the volume is limited to a maximum level of 5 out of 10, instead of 10 out of 10.

Allowing actions can also be referred to as freeing actions, or increasing actions, as just a couple of examples. In various embodiments these include any action that increases or extends a manner or extent to which a user can use one or more select vehicle functions. As an example, an allowing action can include increasing the mentioned setting of the infotainment system so that the volume limit is increased to a maximum level of 8 out of 10, from the prior 5 out of 10.

In various embodiments, the portable system at block 312 also sends, to the host device 150, the action or actuation data (e.g., action or actuation instruction, message, or signal) [1] determined by the flexible policy engine or module 120 based on the vehicle data and/or the application data obtained, and [2] indicating one or more corresponding vehicle actions to be made or taken. The transfer is indicated by path 313 in FIGS. 3 and 4.

The transfer 313 can be made by one or more modules or sub-modules of the portable system 110. As provided, the portable system 110, in various embodiments, includes modules for processing output of the flexible policy engine or module 120. The other modules, shown in FIG. 1, can include: the actuation module 121; the adjustments module 122; the audio-buffer module 123; the visual-media or framebuffer module 124; and the user input/output module 125. The adjustments module 122 can include the audio-buffer adjustment sub-module 220, the framebuffer adjustment sub-module 222, and the user input/output adjustment sub-module 224, as shown in FIG. 2.

The actuation module 121 determines the type of action or actuation needed at the host device 150 based on the actuation data output from the flexible policy engine or module 120.

The adjustments module 122 determines at least one change or adjustment needed at the host device 150 to effect the action or actuation determined at operation 312. Resulting adjustment data, in various embodiments, indicates components of the host device 150 that will effect the action. Resulting adjustment data in some embodiments indicates an actuation module or other module of the portable system 110—such as the audio-buffer module 123, the visual-media or framebuffer module 124, and/or the user input/output module 125.

If the determined action or actuation associated with the adjustment data would affect audio-related functions of the host device 150, for instance, such as whether audible alerts, tones, sound, or communication (music, etc.) will be provided to the user or to what degree (e.g., timing or volume), the adjustment data is provided to the audio-buffer module 123. The mentioned audio-buffer adjustment sub-module 220 of the adjustments module 122 performs this function because the function relates to audio. Example adjustments are provided in Section II.C., below.

If the determined action or actuation associated with the adjustment data would affect visual or video-related functions of the host device 150, for instance, such as how or whether a video is rendered at the host device 150, adjustment data is provided to the visual-media module 124. The mentioned frame buffer adjustment sub-module 222 of the adjustments module 122 performs this function because the function relates to video or other visual presentation.

If the determined action or actuation associated with the adjustment data would affect how the system allows the user to interact with the host device 150, such as whether or to what extent the user can adjust operations of the device 150 via a touch-sensitive screen of the host device 150, adjustment data is provided to the user input/output adjustment module 224 of the adjustments module 122. The mentioned input/output adjustment sub-module 224 of the adjustments module 122 performs this function because the function relates to device input/output (I/O) settings affecting the user's ability to interact with the device 150.

The process 300 can end 315 or any portions thereof can be repeated.

II.C. Example Host-Device Adjustments

As mentioned, the portable system 110 at block 312 determines one or more adjustments to be effected via the host device 150 based on vehicle-operation data, subject-application data, and/or driver data, which in various embodiments is indicted by the vehicle-operation data and/or the subject-application data.

The system 110 can be configured in any of a variety of ways to determine an appropriate policy and/or host-device action to be effected via the host device 150, such as by using a look-up or tuple table.

Example manners of affecting media transfer or rendering include selecting which of various framebuffers or framebuffer settings to use in connection with a media data transfer/rendering, based on the circumstances such as vehicle and/or user condition or state.

Other examples manners to affect media transfer and rendering include limiting or diminishing a characteristic (e.g., speed, quality) of transfer or rendering, such as by slowing a sampling rate at the host vehicle infotainment apparatus, delaying presentation of content, adapting presentation of the content—e.g., adjusting text point size—employing a more-salient theme having higher or increased contrast, simplifying display layout, or using less-demanding communication or sensory channels (less-demanding in any of various ways, such as less demanding on user attention, less demanding on system resources), such as by using audio or haptic instead of video to share media, a communication, or a notification.

Based on such contexts, example system manners of how to transfer or render media, or how to interact with a user regarding the media, include blocking an application from operating entirely. The blocking can include blocking all output from reaching the user from the application, such as by blocking access to an application at a vehicle head-unit display screen or vehicle audio output component, or by controlling (e.g., affecting settings of) the application so that that the application does not generate, or does not output, the subject media to the screen and/or audio component.

The adjustments module 122 or, more specifically in some embodiments, the audio-buffer, adjustment sub-module 220, determines [based on vehicle-operation data, subject-application data, and/or driver data, which in various embodiments is indicted by the vehicle-operation data and/or the subject-application data] audio-related adjustments as mentioned above.

Example adjustments include blocking audio, to some degree, or manipulating audio, such as, in various embodiments:
Completely blocking a select media from being output by a vehicle audio output, such as by blocking video, incoming phone calls, or other communications. The system may be configured in this case to return an automatic unable-to-answer message to the caller. The calls can be blocked at various stages of attempting to connect the call, such as at a server or base station or switching center transferring the call, or at the vehicle 10.
Audio blocking including partially or completely lowering an audio volume that can be output by the vehicle audio component. The system may, based on the underlying conditions, determine to limit output partially, such as by allowing audio output of music or other infotainment at only a volume level 5 out of a possible level 10 while the conditions exist.
Manipulating content (e.g., audio) based on results from the flexible, configurable policy engine or module 120 processing context—vehicle, application, and/or user context, for instance. Manipulations can include, for instance:
   Translating a complex graphic rendering to a more driver-friendly, simplified, graphic rendering, using semantics offered within content or other data of the subject application;
   Selecting or changing to an appropriate, or more-appropriate, framebuffer from a group of optional framebuffers identified at the portable system 110 [which can be referred to as a framebuffer pool] based on the context and policy-engine decision; and/or
   Selecting an appropriate audio template, such as from a group of optional graphic templates identified at the portable system 110 [which can be referred to as an audio-template pool] based on the context and policy-engine decision.

The adjustments module 122 or, more specifically in some embodiments, the visual-media adjustment sub-module 222, determines, based on the vehicle data and the application data, visual-related adjustments, as mentioned above. Example adjustments include visual blocking or manipulation, such as, in various embodiments:
Blocking entirely the host screen from being used to output visual media corresponding to the subject application;
Manipulating or affecting screen output, such as by:
   Down-sampling screen frame rate to less than n frames per second (fps), and provide warning, where n is a determined number greater than zero;
   Manipulating a graphic interface rendered to customers, in order to honor user distraction guidance, such as by using distinct graphic rendering options in connection with corresponding distinct context statuses, such as normal driving, vehicle stationary, and challenging driving;
   Translating a relatively complex graphic rendering to simpler, or more-driver-friendly simplified graphic rendering, using semantics offered within content or other data of or associated with a subject application;
   Selecting or changing to an appropriate, or more-appropriate, framebuffer from a group of optional framebuffers identified at the portable system 110 [which can be referred to as a framebuffer pool] based on the context and policy-engine decision; and
   Selecting an appropriate graphic template, such as from a group of optional graphic templates identified at the portable system 110 [which can be referred to as a graphic-template pool] based on the context and policy-engine decision

The adjustments module 122 or, more specifically in various embodiments, the human-machine-interface (HMI) or user input/output sub-module 224, determines, based on the vehicle data and the application data, user input/output-related, or HMI-related, adjustments, as mentioned above. Example adjustments include HMI blocking, HMI control, and user direction, such as, in various embodiments:
Effecting manners of interacting with the user including limiting user access to vehicle functions, such as user access to touch-screen functionality.
User-input blocking, such as:
   Blocking the system from acting on driver touch input entirely;
   the manner or circumstances by which the driver can provide input to the system, such as by not allowing extended, long duration, operation, by limiting touch frequency allowed, etc.;
Directing the driver to use voice recognition input or gestures, rather than touch under relatively challenging driving environment; and
Directing users to use a physical button rather than a touch screen.

II.D. Example Use Cases

The following sample use cases are provided by way of illustration and not limitation. The samples include example policies linked with example applications and vehicle operations context, the system can be programmed with other policy/application/vehicle operations context combinations and in various implementations the system is configured to change combinations or create new combinations (e.g., other policy added) during implementation of the technology, such as based on user input, a vehicle servicer, remote software update, the like or other.

| | | RESULTING POLICY |
|---|---|---|
| | VEHICLE | AND ACTION TO TAKE |
| | OPERATIONS | AT HOST-DEVICE |
| APPLICATION | CONTEXT | (e.g., vehicle 10) |
| Restaurant | Moving | => Block touch |
| review-and- | | (E.g., block HMI system |
| reservation app | | from reacting to user |
| | | touch, and/or transition to |
| | | voice/dialog mode) |
| Same restaurant | Parked | => No blocking |
| review-and- | | |
| reservation app | | |
| Video app | Moving | => Block touch |
| Same video app | Parked | => No blocking |
| Navigation | Moving | => No blocking of |
| app | | navigation application |
| | | output |
| Incoming call | (i) Moving and | Block call and sent text |
| | (ii) Complex | message to driver and/or |
| | environment | caller - e.g., “unable to |
| | and/or complex | answer - busy driving” |
| | driving | |

II.E. Host Device Operations—FIG. 4

The algorithm 400 of FIG. 4 is described primarily from the perspective of the host device 150 of FIG. 1. As provided, the host device 150 can include or be a part of a head unit, or on-board computer, of a transportation vehicle, such as an automobile, for example.

The algorithm 400 begins 401 and flow proceeds to the first operation 402 whereat the host device 150 is placed in communication with the portable system 110. Connecting with the host device 150 can include connecting by wired or wireless connection 129, 131.

The connection of block 402 can include a handshake process between the host device 150 and the portable system 110, which can also be considered indicated by reference 305 in FIGS. 3 and 4. The process at operation 402 establishes a channel by which data and communications such as messages or instructions, can be shared between the portable system 110 and the host device 150.

For embodiments in which both devices include a dynamic programming language (not shown in detail), such as JavaScript, Java or a C/C++ programming language, the operation 402 can include a handshake routine between the portable system 110 and the host device 150 using the dynamic programming language.

Flow proceeds to block 404 whereat the hardware-based processing unit 154 receives, from the portable system 110, the action data (e.g., action instruction, message, or signal) determined at operation 312 by the portable system 110 (FIG. 3). The transmission is referenced by numeral 313 in connection with associated operation 312 of the portable system 110.

At block 406, the hardware-based processing unit 154 initiates performance of the action or actions indicated by the action data.

As indicated, the actions can include allowing or disallowing system functions, such as by limiting a volume that the infotainment system can be turned up to, limiting an amount of user-touch input, via a vehicle HMI, such as a touch screen display, that the system will process, limiting an amount of information that is displayed to the user, and limiting presentation of notifications, or communications (e.g., phone calls, text), communicated to the user.

The process 400 can end 407 or any portions thereof can be repeated.

### III. SELECT BENEFITS OF THE PRESENT TECHNOLOGY

Many of the benefits and advantages of the present technology are described above. The present section restates some of those and references some others. The benefits are provided by way of example and are not exhaustive of the benefits of the present technology.

The technology includes a system is programmed to avoid or at least limit user-distraction during vehicle operation.

The system selectively controls vehicle functionality to limit user attention taken away from driving. The control is effected based on factors such as a vehicle state or operation and a characteristic of a subject program or application, such as an identity or type of subject application.

### IV. CONCLUSION

Various embodiments of the present disclosure are disclosed herein.

The disclosed embodiments are merely examples that may be embodied in various and alternative forms, and combinations thereof.

The above-described embodiments are merely exemplary illustrations of implementations set forth for a clear understanding of the principles of the disclosure. Variations, modifications, and combinations may be made to the above-described embodiments without departing from the scope of the claims. All such variations, modifications, and combinations are included herein by the scope of this disclosure and the following claims.

What is claimed is:

1. A system, comprising:
a hardware-based processing unit; and
a non-transitory storage device comprising:
a vehicle-context module that, via the hardware-based processing unit, obtains vehicle-context data;
an application-manager module that, via the hardware-based processing unit, obtains application data relating to an application at a host device;
a policy engine that, via the hardware-based processing unit, determines, based on the vehicle-context data and the application data received, a corresponding policy to be effected at the host device; and
an output module that, via the hardware-based processing unit, sends to the host-device a communication indicating an appropriate host-device action, corresponding to the policy determined, for affecting host-device operation according to the appropriate host-device action.

2. The system of claim 1, wherein the system comprises components to:
connect communicatively with and be portable vis-à-vis the host device, the system in this event being a portable system; or
be embedded with the host device or with a vehicle in which the host device is embedded, the system in this event being an embedded system.

3. The system of claim 1 wherein the vehicle-context module comprises:
a vehicle-data acquisition sub-module that, via the hardware-based processing unit, receives vehicle-operation data; and
a vehicle-context inference sub-module that, via the hardware-based processing unit, determines the vehicle-context data based on the vehicle-operation data.

4. The system of claim 1 further comprising:
an audio-buffer component;
a visual-buffer component;
a human-machine interface (HMI) component; and
an actuation module that, via the hardware-based processing unit, determines which one or more of said components to use in processing the policy determined to render the host-device action.

5. The system of claim 3 wherein the actuation module comprises or is in communication with an adjustments module that, via the hardware-based processing unit, generates, based on the policy determined, at least one of:
an audio part, for processing at the audio-buffer component;
a visual part, for processing at the visual-buffer component; and
an HMI part, for processing at the HMI component.

6. The system of claim 1 wherein the vehicle-context data indicates:
whether the vehicle is parked or moving; and/or
that the vehicle is moving and an overall driving-task complexity level.

7. The system of claim 1 wherein the policy includes a human-machine-interface portion indicating whether the host device should block or allow receiving or processing of, user touch via a screen component.

8. The system of claim 1 wherein the policy includes an audio portion indicating a manner by which an audio component of the host device should function.

9. The system of claim 1 wherein the policy includes a video portion indicating a manner by which a visual component of the host device should function.

10. A method, implemented at a system comprising a vehicle-context module, an application-manager module, a policy engine, and a hardware-based processing unit, comprising:
obtaining, by the vehicle-context module, via the hardware-based processing unit, vehicle-context data;
obtaining, by the application-manager module, via the hardware-based processing unit, application data relating to an application at a host device;
determining, by the policy engine, via the hardware-based processing unit, based on the vehicle-context data and the application data received, a corresponding policy to be effected at the host device; and
sending, by the output module that, via the hardware-based processing unit, to the host-device, a communication indicating a host-device action, corresponding to the policy determined, for affecting host-device operation according to the appropriate host-device action.

11. The method of claim 10, comprising:
receiving, by a vehicle-data acquisition sub-module, via the hardware-based processing unit, vehicle-operation data; and
determining, by a vehicle-context inference sub-module, via the hardware-based processing unit, the vehicle-context data based on the vehicle-operation data.

12. The method of claim 10 wherein:
the system further comprises:
an audio-buffer component;
a visual-buffer component;
a human-machine interface (HMI) component; and
an actuation module; and
the method further comprises determining, by the actuation module, via the hardware-based processing unit, which one or more of said components to use in processing the policy determined to render the host-device action.

13. The system of claim 12 wherein:
the actuation module comprises or is in communication with an adjustments module; and
the method further comprises determining, by the actuation module, via the processing unit, and based on the policy determined, at least one of:
an audio part, for processing at the audio-buffer component;
a visual part, for processing at the visual-buffer component; and
an HMI part, for processing at the HMI component.

14. The method of claim 10 wherein the vehicle-context data indicates whether the vehicle is parked or moving.

15. The method of claim 10 wherein the policy includes a human-machine-interface portion indicating whether the host device should block or allow receiving user touch via a screen component.

16. The method of claim 10 wherein the policy includes at least one portion selected from a group consisting of:
an audio portion indicating a manner by which an audio component of the host device should function; and
a video portion indicating a manner by which a visual component of the host device should function.

17. A non-transitory storage device, for implementation at a system, comprising:
a vehicle-context module that, via a hardware-based processing unit of the system, obtains vehicle-context data;
an application-manager module that, via the hardware-based processing unit, obtains application data relating to an application at a host device;
a policy engine that, via the hardware-based processing unit, determines, based on the vehicle-context data and the application data received, a corresponding policy to be effected at the host device; and
an output module that, via the hardware-based processing unit, sends, to the host-device, a communication indicating a host-device action, corresponding to the policy determined, for affecting host-device operation according to the appropriate host-device action.

18. The non-transitory storage device of claim 17 wherein the vehicle-context module comprises:
a vehicle-data acquisition sub-module that, via the hardware-based processing unit, receives vehicle-operation data; and
a vehicle-context inference sub-module that, via the hardware-based processing unit, determines the vehicle-context data based on the vehicle-operation data.

19. The non-transitory storage device 17 further comprising:
an audio-buffer component;
a visual-buffer component;
a human-machine interface (HMI) component; and
an actuation module that, via the hardware-based processing unit, determines which one or more of said components to use in processing the policy determined to render the host-device action.

20. The non-transitory storage device of claim 17 wherein the policy includes at least one portion selected from a group consisting of:
a human-machine-interface portion indicating whether the host device should block or allow receiving or processing of user touch input at a screen component;
an audio portion indicating a manner by which an audio component of the host device should function; and
a video portion indicating a manner by which a visual component of the host device should function.
